(19) United States
(12) Patent Application Publication
(10) Pub. No.: US 2025/0156959 A1
(43) Pub. Date: May 15, 2025

(54) COMPUTER-IMPLEMENTED SYSTEMS AND METHODS FOR DISPERSION OF CLOSING CYCLES

(71) Applicant: Thomas Hecht, Cambridge, MA (US)

(72) Inventor: Thomas Hecht, Cambridge, MA (US)

(21) Appl. No.: 18/509,023

(22) Filed: Nov. 14, 2023

(51) Int. Cl. G06Q 40/12

(52) U.S. Cl. CPC G06Q 40/12

(57) ABSTRACT

According to an aspect of the present invention, there is provided a software system that revolutionizes accounting and auditing procedures by dynamically adjusting fiscal year-end and month-end timelines, fostering resource sharing and collaboration, and introducing reciprocal internal audit functions, aiming to dismantle and reconfigure traditional work structures to enhance efficiency, reduce costs, and improve wellbeing in the industry. Leveraging artificial intelligence and a franchise system, it promises optimized and cooperative industry practices that serve the broader public interest while maintaining the industry's stringent standards.

### BACKGROUND

Computer-implemented systems and methods relating to accounting are well known in the patent literature.

As one example, U.S. Pat. No. 10,387,858 discloses a cash flow management system provided within a host system for facilitating cash flow management for businesses. The cash flow management system includes an electronic billing and invoicing computing system enabling generation and transmission of electronic bills based on business invoices and for displaying the generated bills for payment and an integrated receivables and reconciliation system receiving notification of received payments and for matching received payments with the generated invoices. The system additionally includes a communication interface for allowing the cash flow management system to communicate with multiple financial management systems accessible to the host enterprise, the systems including at least an accounting system, the integrated receivables management system receiving information from the financial management systems within the host system to facilitate management of cash flow for the businesses using the cash flow management system for electronic billing.

U.S. Pat. No. 11,176,606 discloses a computer system that categorizes a financial transaction. During operation, the computer system receives information specifying the financial transaction for an individual. Then, the computer system determines one or more scores indicating a likelihood that the financial transaction is associated with one or more predefined categories based on numbers of occurrences of the one or more predefined categories in financial-transaction histories of a subset of a group of individuals.

Nonetheless, improved computer-implemented accounting systems and methods are desirable, particularly computer-implemented methods and systems which address the inefficient, conventional fiscal year-end and month-end close cycles.

### SUMMARY OF INVENTION

Accordingly, the present invention pertains to a software system and method designed to revolutionize the accounting and auditing landscape. This innovative approach seeks to disassemble and reconfigure the conventional protocols regarding the fiscal year-end timelines and workload distribution mechanisms among CPAs and other professionals in accounting firms, optimizing the resource pool in a manner that is beneficial for all involved parties, including the general public. By shifting away from the traditional December 31 year-end and redistributing month-ends, the software mitigates the ‘busy season’ bottleneck, facilitating a balanced workload, reducing premiums charged by audit firms, and improving the wellbeing of professionals. It encourages entities to share resources and collaborate more deeply, including reciprocating internal audit functions to maintain independence and enhance efficiency in the industry.

According to an aspect of the present invention, there is provided a computer-implemented method for dynamically adapting fiscal year-end and month-end timelines, the method comprising: storing electronic transaction records identified by date; receiving a selected date range from a user at an input/output device associated with a computer terminal; identifying the subset of electronic transaction records which have dates within the date range selected by the user; and calculating one or more financial metrics based on the subset of electronic transaction records.

According to another aspect of the present invention, the method further comprises defining a digital standardized 4-4-5 date format implementing a 4-4-5 calendar and relabeling the stored electronic transaction records identified by calendar dates with a corresponding digital standardized 4-4-5 date.

According to yet another aspect of the present invention, the method further comprises defining a digital standardized international fixed calendar date format implementing the international fixed calendar; and relabeling the stored electronic transaction records identified by calendar dates with a corresponding digital standardized international fixed calendar date.

### BRIEF DESCRIPTION OF THE DRAWINGS

FIG. 1 illustrates a flow chart according to the present invention.

### DETAILED DESCRIPTION

Systems and methods of the present invention support the disaggregation and reassembly of data. An example is in the practice of accounting. People prefer symmetry and as a result, most companies have their year-end as December 31, when in reality companies' year end could be any other day of the year. The December 31 dynamic creates a supply and demand mismatch for regulated and/or deadline-driven services including audit and tax, resulting in a needless premium for those services. Similarly, month closes are often the last day of a month when it could be any day. A 4-4-5 calendar (4 weeks, 4 weeks, 5 weeks per quarter for consistent financial reporting) can be used in embodiments.

Recurring functions like monthly close have ebbs and flows of workload. The present disclosure provides for multiple entry points (ex: bottom-up, top-down, middle-out). Functions from entities can be siphoned and optimized in a pooling fashion. In the example, systems and methods can funnel the accounting function to a specialized accounting entity and restate a more optimal year-end that balances with the fulfillment entity. This method can apply to many functions within a company or institution.

The invention pertains to a software system and method designed to revolutionize the accounting and auditing landscape. This innovative approach seeks to disassemble and reconfigure the conventional protocols regarding the fiscal year-end timelines and workload distribution mechanisms among CPAs and other professionals in accounting firms, optimizing the resource pool in a manner that is beneficial for all involved parties, including the general public. By shifting away from the traditional December 31 year-end and redistributing month-ends, the software mitigates the ‘busy season’ bottleneck, facilitating a balanced workload, reducing premiums charged by audit firms, and improving the wellbeing of professionals. It encourages entities to share resources and collaborate more deeply, including reciprocating internal audit functions to maintain independence and enhance efficiency in the industry.

The present invention is a transformative software solution set to restructure the accounting industry, particularly targeting the inefficient, conventional fiscal year-end and month-end close cycles that overwhelmingly converge on specific periods, creating undue pressure and elevated costs. The unique system envisaged leverages the expertise and capabilities of in-house professionals, including CPAs, to offer an alternative, more balanced, and collaborative approach to managing workloads and executing audit functions.

Traditionally, a significant number of companies align their financial year-end with the calendar year-end, i.e., December 31, to align with tax planning and other regulatory requirements, albeit not mandated. This alignment has led to a ‘busy season’ characterized by heightened work pressure and premium service charges by independent audit firms. The accounting industry is notably cyclical, with workload imbalances occurring monthly, mainly as month-end close cycles traditionally conclude on the last day of the month.

The present invention provides for Dynamic Fiscal Year-End Adjustment. The software facilitates a dynamic adaptation of the fiscal year-end and month-end dates, enabling a decentralized dispersion of these critical accounting periods across various dates. This dispersion alleviates the pressure of the busy season, enhancing efficiency and reducing the premiums charged by independent audit firms during these peak periods.

According to an embodiment of the present invention, there is provided Resource Sharing and Collaborative Environment functionality. A salient feature of this invention is fostering a collaborative environment wherein entities can share resources, effectively leveraging the expertise and capabilities of professionals within different organizations. It thus paves the way for a more balanced workload distribution across the month, avoiding the traditional end-of-month rush and promoting resource optimization.

According to an embodiment of the present invention, there are provided Alternative Internal Audit Solutions. The software proposes an innovative alternative to the traditional independent audit process. Although audit firms were initially conceived to offer independent auditing services, the invention recognizes that CPAs and professionals within organizations possess the requisite competence, independence, and expertise to provide viable alternatives. This alternative leverages the depth of experience and skills within organizations, allowing for a more integrative and reciprocal audit function that maintains the necessary independence standards while offering a more reliable and efficient solution.

According to an embodiment of the present invention, there are provided Reciprocal Internal Audit Functions. The system facilitates a groundbreaking approach where firms can reciprocate internal audit functions, allowing a heightened level of reliance on internal audit work, ultimately fostering a more efficient, collaborative, and cost-effective auditing landscape. This function recognizes and utilizes the innate capabilities of in-house professionals, transforming the auditing process into a more collaborative, efficient, and reliable endeavor.

By dynamically adapting fiscal year-end and month-end timelines and encouraging reciprocal internal audit functions, the system promotes a decentralized, collaborative, and harmonious working landscape, promising remarkable improvements in the efficiency and wellbeing of professionals in the industry. It is a pioneering approach, aiming to serve the broader public interest while retaining the stringent standards of independence and competence that are the hallmarks of the industry. It leverages artificial intelligence and a franchise system to introduce a novel era of optimized, cooperative, and streamlined industry practices.

In service of the above, the present invention provides a Collaborative and Optimized Resource Management System. The system and method for the systematic disaggregation and reassembly of corporate and business entities designed to streamline and optimize labor capital and resources in accounting and related industries characterized by: Resource Database Formation: Establishing a database that encompasses professionals, including Certified Public Accountants (CPAs) who meet stringent prerequisites, providing a comprehensive outline of their expertise, industry knowledge, and experience. b. Regulatory Adherence: Enforcing financial and relationship disclosures to ensure adherence to the rules of independence as dictated by regulatory bodies. c. Franchise Entity Structure: Establishing a franchise system where a parent organization functions as the general partner, overseeing networks of business entities that unite individual professionals into teams to offer a consistent audit product. d. Flexible Fiscal Year-Ends: Implementing an adaptive process to move year-ends away from high-demand periods, such as December 31, to avert service premiums and facilitate more balanced workloads year-round.

The present invention provides an Adaptive Engagement Approach A strategy encompassing: a. Utilizing In-house Professionals for External Roles: Leveraging professionals from within entities who meet the necessary standards to perform functions generally outsourced to independent accounting firms, including adjusting month-ends to distribute evenly throughout the month, balancing workloads. b. Alternative Internal Audit Function: Offering an alternative to traditional internal audit functions, promoting independence and fostering conditions that allow for complete reliance on the work performed by internal teams. c. Scalable Best Practices: Scaling established best practices of existing accounting functions to include workflows from other businesses, applying to various core functions within an entity. d. Quarterly Audit During Year-End Changes: Ensuring modifications in the fiscal year-end are paired with a quarterly audit and dual reporting to uphold the comparability of financial statements. e. Control Design and Testing: Incorporating a control design and verification phase during quarterly audits before transitioning back to quarterly reviews.

The present invention provides a Dynamic Pricing Engine Integration, a mechanism characterized by: a. Efficiency Leveraging: Deploying a pricing engine that leverages efficiency gains and risk mitigation to offer discounted services. b. Dynamic Market Analysis: Engaging in a systematic analysis of market demands and workload distributions to dynamically adjust pricing.

The present invention provides an Intelligent Workflow Management A system fostering: a. Workload Distribution: Balancing workload across different accounting functions through an intelligent workflow management tool, encouraging collaboration and mutual benefits among entities.

The present invention provides Promotion of Public Interest A system characterized by: a. Cooperative Strategy: Adopting a cooperative approach that promotes public interest by optimizing the use of qualified professionals for the greater benefit of the industry, clients, and the public at large.

The present invention provides Facilitative Platform for Quarterly Audits A platform facilitating: a. Comparative Financial Statements: Developing a platform to facilitate quarterly audits, enabling the construction of comparative financial statements over required periods while concurrently optimizing internal control measures.

The present invention provides Transformative Auditing Approach A method promoting: a. Reliable Internal Controls: Instituting and validating effective control operations to nurture dependable internal controls, paving the way for potential outsourcing to independent firms and enhancing audit reliability through reciprocal arrangements.

The present invention provides Consultancy Insight Synthesis An approach to consultancy involving: a. Consultancy Based on Best Practices: Providing consultancy services leveraging insights drawn from an in-depth understanding of general and administrative processes, with a view to scaling operations for heightened efficiency.

The present invention provides an AI-Integrated Regulatory Compliance System A system denoted by: a. AI-Enabled Compliance: Integrating AI mechanisms to secure compliance with current legal frameworks, dynamically adapting to shifting legal landscapes and poised to disrupt traditional practices in the industry.

The system aims to decentralize the dispersion of fiscal timelines across different companies to avoid everyone closing their books at the same time. By spreading out the workload, the goal is to achieve a more balanced workload distribution throughout the year.

To implement this, companies would analyze their workload distribution, identify alternative closing dates, and utilize the system to store electronic transaction records and calculate financial metrics based on the selected date ranges.

The system also promotes resource optimization and collaboration among entities. Companies can make better use of their internal and external resources, including audit firms, by coordinating and sharing expertise.

It's important for companies to ensure that any changes to their fiscal year-end or month-end timelines comply with regulatory requirements. This may involve communication with regulatory bodies and adjusting reporting schedules.

Effective communication is vital to inform all stakeholders, including employees, audit firms, and investors, about the changes. Once communicated, companies can implement the new timelines and align their processes accordingly.

Periodic reviews are conducted to assess the effectiveness of the adapted timelines. Adjustments can be made as needed based on changing workloads, regulatory requirements, or other factors.

By implementing this dynamic approach, companies aim to achieve a better balance of workloads, reduce stress during peak periods, optimize resources, and potentially reduce costs associated with auditing and financial reporting. The system allows for flexibility and adaptability to meet evolving needs and requirements.

The benefits of dynamically adapting fiscal year-end and month-end timelines in the accounting industry are as follows:

Balanced Workload: By redistributing month-ends and shifting away from the traditional December 31 year-end, the software helps to alleviate the workload imbalance that occurs during busy seasons. This leads to a more balanced workload throughout the year, reducing the pressure on accounting professionals and improving their wellbeing.

Reduced Premiums: The software mitigates the “busy season” bottleneck, which often results in increased service charges by independent audit firms. By spreading out critical accounting periods and reducing demand during peak periods, the software helps to reduce the premiums charged by audit firms, resulting in cost savings for businesses.

Resource Optimization: The software encourages entities to share resources and collaborate more deeply. It facilitates the pooling of accounting functions to specialized accounting entities and optimizes year-end dates to align with fulfillment entities. This resource sharing and optimization contribute to greater efficiency and effectiveness in accounting processes.

Collaborative Environment: The software fosters a collaborative environment where entities can share resources and leverage the expertise and capabilities of professionals within different organizations. This promotes collaboration, knowledge sharing, and improved overall performance in the industry.

Alternative Internal Audit Solutions: The software introduces an alternative to traditional independent audit processes. It recognizes that CPAs and professionals within organizations possess the necessary competence and independence to provide viable alternatives. This alternative approach utilizes in-house professionals, maintaining independence standards while offering a more efficient and reliable audit solution.

Reciprocal Internal Audit Functions: The software facilitates reciprocal internal audit functions, allowing firms to reciprocate internal audit functions. This fosters a higher level of reliance on internal audit work, enhancing efficiency, collaboration, and cost-effectiveness in the auditing landscape.

Summarily, dynamically adapting fiscal year-end and month-end timelines in the accounting industry brings numerous benefits such as balanced workloads, reduced premiums, resource optimization, a collaborative environment, alternative internal audit solutions, and reciprocal internal audit functions. These benefits lead to improved efficiency, cost savings, and enhanced wellbeing for professionals in the industry.

In the disclosed accounting system, while the predominant calendar utilized for financial reporting purposes is the Gregorian calendar, it should be recognized by those skilled in the art that the International Fixed Calendar can also be applied to achieve consistent and standardized reporting intervals. The International Fixed Calendar, which consists of 13 months each comprising 28 days, inherently introduces a week that does not conform to the traditional monthly structure. In the context of financial reporting using this system, this non-conforming week could be judiciously appended to one of the quarters, ensuring uniformity in reporting periods. The adoption of such a calendar might provide enhanced comparability and consistency in financial statements and is contemplated within the scope of this invention.

An integral component of the disclosed accounting system involves cutoff procedures that ensure transactions are reported in the appropriate periods. Given the inherent differences between the Gregorian calendar and the International Fixed Calendar, reconciliation mechanisms are essential when operating with both. By aligning the cutoff procedures between the two calendars, it becomes feasible to restate periods with minimal additional effort if the need arises. This dual-calendar capability allows entities to leverage the consistency offered by the International Fixed Calendar while retaining the flexibility to report or restate in accordance with the widely-accepted Gregorian calendar. The system's design ensures that reconciling the two calendars is streamlined and is intrinsically tied to the cutoff procedures, thereby reducing the complexities typically associated with managing multiple reporting calendars.

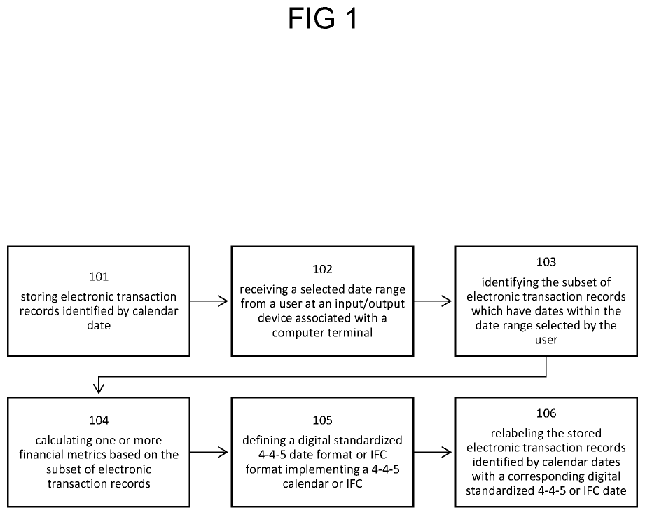

FIG. 1 illustrates a flow chart according to the present invention.

Step 101 is storing electronic transaction records identified by calendar date.

Step 102 is receiving a selected date range from a user at an input/output device associated with a computer terminal.

Step 103 is identifying the subset of electronic transaction records which have dates within the date range selected by the user.

Step 104 is calculating one or more financial metrics based on the subset of electronic transaction records.

Step 105 is defining a digital standardized 4-4-5 date format or IFC format implementing a 4-4-5 calendar or IFC.

Step 106 is relabeling the stored electronic transaction records identified by calendar dates with a corresponding digital standardized 4-4-5 or IFC date.

It should be appreciated and understood that the present invention may be embodied as systems, methods, apparatus, computer readable media, non-transitory computer readable media and/or computer program products. The present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” The present invention may take the form of a computer program product embodied in one or more computer readable medium(s) having computer readable program code embodied thereon.

In some embodiments, the software programming is web-based and written in HTML and JAVA programming languages, including links to user interfaces for data collection, such as a WINDOWS® based operating system, and each of the main components may communicate via a network using a communication bus protocol. For example, the present invention may or may not use a TCP/IP protocol suite for data transport. Other programming languages and communication bus protocols suitable for use with the present invention will become apparent to those skilled in the art after reading the present application. Components of the present invention may also reside in software on one or more computer-readable mediums. The term “computer-readable medium” as used herein is defined to include any kind of memory, volatile or non-volatile, such as floppy disks, hard disks, CD-ROMs, flash memory, read-only memory (ROM), and random excess memory (RAM).

In execution of the present invention, one or more computer readable medium(s) may be utilized, alone or in combination. The computer readable medium may be a computer readable storage medium or a computer readable signal medium. A suitable computer readable storage medium may be, for example, but not limited to, an electronic, magnetic, optical, electromagnetic, infrared, or semiconductor system, apparatus, or device, or any suitable combination of the foregoing. Other examples of suitable computer readable storage medium include, without limitation, the following: an electrical connection having one or more wires, a portable computer diskette, a hard disk, a random access memory (RAM), a read-only memory (ROM), an erasable programmable read only memory (EPROM or flash memory), an optical fiber, an optical storage device, a magnetic storage device, or any suitable combination of the foregoing. A suitable computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Python, C++ or the like and conventional procedural programming languages, such as the “C” programming language or similar programming languages. The program code may execute entirely on the user's computing device (such as, a computer), partly on the user's computing device, as a stand-alone software package, partly on the user's computing device and partly on a remote computing device or entirely on the remote computing device or server. In the latter scenario, the remote computing device may be connected to the user's computing device through any type of network, including a local area network (LAN) or a wide area network (WAN), or the connection may be made to an external computing device (for example, through the Internet using an Internet Service Provider).

The present invention is described herein with reference to flowchart illustrations and/or block diagrams, can be implemented by computer program instructions. These computer program instructions may be provided to a processor of a general purpose computing device (such as, a computer), special purpose computing device, or other programmable data processing apparatus to produce a machine, such that the instructions, which execute via the processor of the computing device or other programmable data processing apparatus, create means for implementing the functions/acts specified in the flowchart and/or block diagram block or blocks.

These computer program instructions may also be stored in a computer readable medium that can direct a computing device, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computing device, other programmable data processing apparatus, or other devices to cause a series of operational steps to be performed on the computing device, other programmable apparatus or other devices to produce a computer implemented process such that the instructions which execute on the computing device or other programmable apparatus provide processes for implementing the functions/acts specified in the flowchart and/or block diagram block or blocks.

It should be appreciated that the function blocks or modules shown in the drawings illustrate the architecture, functionality, and operation of possible implementations of systems, methods and computer program media and/or products according to various embodiments of the present invention. In this regard, each block in the drawings may represent a module, segment, or portion of code, which comprises one or more executable instructions for implementing the specified logical function(s). It should also be noted that, in some alternative implementations, the functions noted in the block may occur out of the order noted in the figures. For example, the function of two blocks shown in succession may, in fact, be executed substantially concurrently, or the blocks may sometimes be executed in the reverse order, depending upon the functionality involved.

It will also be noted that each block and combinations of blocks in any one of the drawings can be implemented by special purpose hardware-based systems that perform the specified functions or acts, or combinations of special purpose hardware and computer instructions. Also, although communication between function blocks or modules may be indicated in one direction on the drawings, such communication may also be in both directions.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer-implemented method for dynamically adapting fiscal year-end and month-end timelines, the method comprising:
storing electronic transaction records identified by calendar date;
receiving a selected date range from a user at an input/output device associated with a computer terminal;
identifying the subset of electronic transaction records which have dates within the date range selected by the user; and
calculating one or more financial metrics based on the subset of electronic transaction records.

2. The method of claim 1, further comprising:
defining a digital standardized 4-4-5 date format implementing a 4-4-5 calendar; and
relabeling the stored electronic transaction records identified by calendar dates with a corresponding digital standardized 4-4-5 date.

3. The method of claim 1, further comprising:
defining a digital standardized international fixed calendar date format implementing the international fixed calendar; and
relabeling the stored electronic transaction records identified by calendar dates with a corresponding digital standardized international fixed calendar date.

4. The method of claim 1, wherein one of the one or more the financial metric is selected from the group comprising revenue, expenses, and profit.

5. The method of claim 1, wherein the method is web-based and written in HTML and JAVA programming languages.

6. The method of claim 1, wherein the selected date range differs from the calendar year.

7. The method of claim 1, further comprising sending at least one of the one or more financial metrics over an electronic communications linkage.

8. The method of claim 1, further comprising sending at least one of the subset of electronic transaction records over an electronic communications linkage to a member of a decentralized audit network.

9. The method of claim 8, wherein the decentralized audit network comprises a database that encompasses professionals, including Certified Public Accountants (CPAs).

10. The method of claim 1, further comprising sending at least one of the subset of electronic transaction records over an electronic communications linkage to an AI engine.

11. The method of claim 1, further comprising aggregating transaction records from two or more accounting entities.

12. The method of claim 2, further comprising providing a reconciliation template between the Gregorian calendar and the 4-4-5 calendar.

13. The method of claim 12, further comprising providing a digital file based on the reconciliation template.
